(19) United States
(12) Patent Application Publication
(10) Pub. No.: US 2022/0374335 A1
(43) Pub. Date: Nov. 24, 2022

(54) TECHNIQUES FOR MULTI-TENANT SOFTWARE TESTING USING AVAILABLE AGENT ALLOCATION SCHEMES

(71) Applicant: Infor (US), LLC, New York, NY (US)

(72) Inventors: Jeffrey Allen Brown, Colorado Springs, CO (US); Herath Mudiyanselage Udara Isuruwan Herath, Colombo (LK)

(21) Appl. No.: 17/328,900

(22) Filed: May 24, 2021

(51) Int. Cl. G06F 11/36

(52) U.S. Cl. CPC G06F 11/3664; G06F 11/3688

(57) ABSTRACT

Various embodiments of the present invention provide methods, apparatuses, systems, computing devices, computing entities, and/or the like for executing efficient and reliable techniques for multi-tenant software testing an using available agent allocation scheme that comprises one or more agent-tenant allocation recommendations, where each agent-tenant allocation recommendation associates an automated testing execution agent in an available agent subset with a test automation tenant in a throttled tenant subset.

### BACKGROUND

Various embodiments of the present invention address technical challenges related to multi-tenant automated software testing and make substantial technical improvements to improving the computational efficiency and operational reliability of test automation platforms. Various embodiments of the present invention makes important technical contributions to the operational reliability of software applications that are tested using the software application platforms.

### BRIEF SUMMARY

In general, embodiments of the present invention provide methods, apparatuses, systems, computing devices, computing entities, and/or the like for executing efficient and reliable techniques for multi-tenant software testing using available agent allocation scheme that comprises one or more agent-tenant allocation recommendations, where each agent-tenant allocation recommendation associates an automated testing execution agent in an available agent subset with a test automation tenant in a throttled tenant subset.

In accordance with one aspect, a method is provided. In one embodiment, the method comprises: identifying, using one or more processors, a total agent pool comprising a group of automated testing execution agents, wherein the total agent pool comprises: (i) for each test automation tenant, an allocated agent subset, and (ii) an available agent subset comprising each automated testing execution agent that is not allocated to the plurality of test automation tenants; determining, using the one or more processors, a throttled tenant subset of the plurality of test automation tenants, wherein each allocated agent subset for a test automaton tenant in the throttled tenant subset fails to satisfy a minimum agent allocation requirement for the test automaton tenant; determining, using the one or more processors, an available agent allocation scheme that comprises one or more agent-tenant allocation recommendations, wherein each agent-tenant allocation recommendation associates an automated testing execution agent in the available agent subset with a test automation tenant in the throttled tenant subset; and executing, using the one or more processors, one or more agent allocation operations based at least in part on the available agent allocation scheme.

In accordance with another aspect, a computer program product is provided. The computer program product may comprise at least one computer-readable storage medium having computer-readable program code portions stored therein, the computer-readable program code portions comprising executable portions configured to: identify a total agent pool comprising a group of automated testing execution agents, wherein the total agent pool comprises: (i) for each test automation tenant, an allocated agent subset, and (ii) an available agent subset comprising each automated testing execution agent that is not allocated to the plurality of test automation tenants; determine a throttled tenant subset of the plurality of test automation tenants, wherein each allocated agent subset for a test automaton tenant in the throttled tenant subset fails to satisfy a minimum agent allocation requirement for the test automaton tenant; determine an available agent allocation scheme that comprises one or more agent-tenant allocation recommendations, wherein each agent-tenant allocation recommendation associates an automated testing execution agent in the available agent subset with a test automation tenant in the throttled tenant subset; and execute one or more agent allocation operations based at least in part on the available agent allocation scheme.

In accordance with yet another aspect, an apparatus comprising at least one processor and at least one memory including computer program code is provided. In one embodiment, the at least one memory and the computer program code may be configured to, with the processor, cause the apparatus to: identify a total agent pool comprising a group of automated testing execution agents, wherein the total agent pool comprises: (i) for each test automation tenant, an allocated agent subset, and (ii) an available agent subset comprising each automated testing execution agent that is not allocated to the plurality of test automation tenants; determine a throttled tenant subset of the plurality of test automation tenants, wherein each allocated agent subset for a test automaton tenant in the throttled tenant subset fails to satisfy a minimum agent allocation requirement for the test automaton tenant; determine an available agent allocation scheme that comprises one or more agent-tenant allocation recommendations, wherein each agent-tenant allocation recommendation associates an automated testing execution agent in the available agent subset with a test automation tenant in the throttled tenant subset; and execute one or more agent allocation operations based at least in part on the available agent allocation scheme.

### BRIEF DESCRIPTION OF THE DRAWINGS

Having thus described the invention in general terms, reference will now be made to the accompanying drawings, which are not necessarily drawn to scale, and wherein:

FIG. 1 provides an exemplary overview of a system that can be used to practice embodiments of the present invention;

FIG. 2 provides an example web server computing entity in accordance with some embodiments discussed herein;

FIG. 3 provides an example client computing entity in accordance with some embodiments discussed herein;

FIG. 4 is a flowchart diagram of an example process for managing multi-tenant execution of a group of automated execution run data entities associated with a plurality of test automation tenants in accordance with some embodiments discussed herein;

FIG. 5 is a flowchart diagram of an example process for generating an available agent allocation scheme in accordance with some embodiments discussed herein;

FIG. 6 is a flowchart diagram of an example process for executing agent allocation operations based at least in part on an available agent allocation scheme in accordance with some embodiments discussed herein; and

FIG. 7 is a flowchart diagram of an example process for executing an internally-executed automated execution run data entity in accordance with some embodiments discussed herein.

### DETAILED DESCRIPTION

Various embodiments of the present invention are described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “exemplary” are used to be examples with no indication of quality level. Like numbers refer to like elements throughout.

### Overview and Technical Advantages

Various embodiments of the present invention provide techniques for allocating test execution resources in an optimized manner among two or more test automation tenants of a test automation platform. For example, various embodiments of the present invention enable generating an available agent allocation scheme that comprises one or more agent-tenant allocation recommendations, wherein each agent-tenant allocation recommendation associates an automated testing execution agent in the available agent subset with a test automation tenant in the throttled tenant subset, and executing one or more agent allocation operations based at least in part on the available agent allocation scheme. The disclosed techniques decrease average user wait-time that may come about as a result of nonoptimal testing resource allocation, thus reducing the computational load on test automation platforms. In this way, various embodiments of the present invention improve the computational efficiency and operational reliability of test automation platforms. For example, consider a scenario in which a user U1 associated with a test automation tenant T1 and a user U2 associated with a test automation tenant T2. In the absence of optimal testing resource allocation, one of U1 and U2 may have to wait while interacting with the test automation platform, which incurs unnecessary computational/operational costs on the noted test automation platform. By reducing this wait time, various embodiments of the present invention improve the computational efficiency and operational reliability of test automation platforms.

Furthermore, various embodiments of the present invention enable optimal testing resource allocation that optimizes the accuracy/reliability of test automation operations performed across tenant, a feature that may reduce the number of erroneous testing operations. In some embodiments, by reducing the number of erroneous testing operations, various embodiments of the present invention improve the operational efficiency of test automation platforms by reducing the number of processing operations that need to be executed by the noted test automation platforms in order to enable software testing operations (e.g., automated software testing operations). By reducing the number of processing operations that need to be executed by the noted test automation platforms in order to execute software testing operations, various embodiments of the present invention make important technical contributions to the field of software application testing. Accordingly, by enhancing the accuracy and reliability of automated testing workflow data entities generated by software testing engineers, the user-friendly and intuitive automated testing workflow generation techniques described herein improve the operational reliability of software application frameworks that are validated using the improved software testing operations described herein. By enhancing the operational reliability of software application frameworks that are validated using the improved software testing operations described herein, various embodiments of the present invention make important technical contributions to the field of software application framework.

Moreover, embodiments of the present invention address technical challenges associated with efficiently and effectively generating and visualizing software testing operations. Various existing software testing solutions are not user-friendly and require high technical software knowledge and intimate familiarity with the software being tested. Furthermore, various existing software testing solutions do not operate in visually intuitive forms. To address the noted efficiency and effectiveness challenges associated with various existing software testing solutions, various embodiments of the present disclosure describe software testing operations related to generating and/or modifying automated testing workflow data entities in a visual and user-friendly manner. Various embodiments of the present disclosure also utilize a multi-tenant cloud architecture allowing multiple clients to utilize the embodiments of the present disclosure and to share software testing operations between themselves, such as part of a Software-as-a-Service (SaaS) architecture. In doing so, various embodiments of the present invention address technical challenges associated with efficiency and reliability of various software testing solutions. In some embodiments, the multi-tenant cloud architecture enables sharing platform costs across multiple clients, thereby reducing costs of a test automation platform, which, in conventional test automation platforms, are very expensive. By allowing customers to share the burden of costs, various embodiments of the present invention reduce the overall cost for the parties who interact/utilize a test automation platform.

In some embodiments, a proposed system is configured to ensure that, at any one given time, up to K number of test automation tenants can launch up to M number of execution run data entities, where each execution run data entity may contain up to N number of test case data entities. Without this agent throttling, the system may not be able to control costs. Aspects of the present invention balance costs by ensuring that, while the minimum required number of automated testing execution agents are at each time allocated to each test automation tenant, costs are reduced via assuming that not all of the K test automation tenants launch execution runs in parallel. In some embodiments, the proposed system assumes that, at each time, the average number of execution runs launched in parallel by each of the K number of test automation tenants is A or fewer, and thus maintains A*K automated testing execution agents. In some of the noted embodiments, the proposed system triggers an override logic to spawn new automated testing execution agents beyond the maintained A*K automated testing execution agents if a violation of the noted assumption is detected. In some embodiments, the proposed system is configure to maintain a minimum of live automated testing execution agents at each time.

In some embodiments, upon executing an execution run, an automated testing execution agent (e.g., an externally-executed automated testing execution agent) may first determine whether the corresponding execution run data entity and/or the corresponding test case data entity is out of date and/or contains updates. If so, the automated testing execution agent may first update the corresponding execution run data entity and/or the corresponding test case data entity before executing the execution run. This reduces the number of erroneous/outdated testing operations performed by software testing platforms and thus reduce the operational load on the noted platforms.

### Definitions of Certain Terms

The term “execution plan data entity” may refer to a data construct that is configured to describe a collection of test case data entities. For example, an execution plan data entity may describe a set of test case data entities that are generated based at least in part on a set of execution plan definition tags. In some embodiments, when an execution plan data entity is determined based at least in part on a set of test case data entities that are generated based at least in part on set of execution plan definition tags, the execution plan data entity may be referred to herein as a “dynamic execution plan data entity.” As another example, an execution plan data entity may describe a set of test case data entities that are explicitly selected by an end user of a web server computing entity. In some embodiments, when an execution plan data entity describes a set of test case data entities that are explicitly selected by an end user of a web server computing entity, the execution plan data entity may be referred to herein as a “static execution plan data entity.” Moreover, as described herein, the set of test case data entities described by an execution plan data entity may be referred to as the planned test case subset for the execution plan data entity. In some embodiments, execution plan data entities include worksheet execution plan data entities that are generated based at least in part on previously-documented execution run data entities, as further described below.

The term “execution run data entity” may refer to a data construct that is configured to describe a defined execution of an execution plan data entity, such as a defined automated execution of an execution plan data entity. In some embodiments, when an execution run data entity describes an automated execution of an execution plan data entity, the execution run data entity is referred to herein as an “automated execution run data entity.” In some embodiments, an execution run data entity is determined based at least in part on a set of execution run definition parameters for the execution run data entity, such as an execution run automation parameter for the execution run data entity that describes whether the execution run data entity is an automated execution run data entity; an execution run scheduling parameter for the execution run data entity that describes whether the execution run data entity should be executed once, periodically (e.g., in accordance with a defined periodicity), or in an on-demand manner as demanded by end users; an execution run parallelization parameter for the execution run data entity that describes whether the execution run data entity should be performed sequentially or in parallel; and an execution run web environment parameter for the execution run data entity that describes the Uniform Resource Locator (URL) for a base (i.e., starting) webpage of the execution run data entity.

The term “test case data entity” may refer to a data construct that is configured to describe data associated with a test case, where the test case may in turn describe a specification of the inputs, execution conditions, testing procedure, and expected results (e.g., including explicitly defined assertions as well as implicitly generated expected results such as the expected result that typing a value into a field causes the value to appear in the field) that define a test that is configured to be executed to achieve a particular software testing objective, such as to exercise a particular program path or to verify compliance with a specific operational requirement. In some embodiments, the test case data entity may be configured to describe test case data (e.g., webpage sequence data, user interaction sequence data, and/or the like) associated with a corresponding test case. In some embodiments, a test case data entity is configured to describe: (i) one or more test case page images associated with the test case, and (ii) for each test case page image of the one or more test case page images, a set of test case steps (e.g., an ordered set of test case steps) that relate to the test case page image.

The term “test case page image” may refer to a data construct that is configured to describe an image associated with a state of a webpage that is visited during a test. For example, in some embodiments, a test case page image may depict a webpage image that is determined based at least in part on a session data entity associated with the test case data entity (as further described below). As another example, in some embodiments, a test case page image may depict a user-uploaded and/or user-selected image that is configured to depict a state of a webpage associated with a corresponding test case data entity. In some embodiments, each visited webpage associated with a test case data entity may be associated with more than one test case page image, where each test case page image may depict a different state of the visited webpage. For example, consider a webpage that includes a dropdown menu interactive page element. In the noted example, some test case page images associated with the webpage may depict a visual state of the webpage in which the dropdown menu interactive page element is in a non-expanded state, while other test case page images associated with the webpage may depict a visual state of the webpage in which the dropdown menu interactive page element is in an expanded state. As another example, consider a webpage that is configured to generate a transitory notification (e.g., a transitory notification that is generated in response to a defined user action, such as in response to the user hovering over an interactive page element and/or in response to the user selecting an interactive button). In the noted example, some test case page images associated with the webpage may depict a visual state of the webpage in which the transitory notifications are displayed, while other test case page images associated with the webpage may depict a visual state of the webpage in which the transitory notifications are not displayed.

The term “test case step” may refer to a data construct that is configured to describe a user action required by a test associated with a corresponding test case data entity, where the user action may be performed with respect to an interactive page element of a webpage associated with a test case page image of the corresponding test case data entity. In some embodiments, a test case step may be associated with test case data used to generate at least one of the following: (i) a visual element identifier overlaid on the test case page image in an overlay location associated with a region of the test case page image that corresponds to the interactive page element for the test case step (e.g., is defined in relation to the interactive page element, for example is placed at the upper left of the interactive page element); and (ii) a test case step action feature that comprises one or more action features of the user action associated with the test case step. For example, if a test case step corresponds to the user action of selecting a particular button on a particular webpage, the test case step may describe data corresponding to a visual element identifier overlaid on an image region of a test case page image for the particular webpage that corresponds to (e.g., is defined in relation to) a location of the particular button on the particular webpage. In the noted example, the test case step may describe data associated with action features of a user action that may be used to generate a test case step action feature. An action feature of a user action may describe any property of a user action that is configured to change a state and/or a value of an interactive page element within a webpage. Examples of action features for a user action include: (i) a user action type of the user action that may describe a general input mode of user interaction with the interactive page element associated with the user action; (ii) a user input value of the user action that may describe a value provided by the user to an interactive page element; (iii) a user action sequence identifier of the user action that may describe a temporal order of the user action within a set of sequential user actions performed with respect to interactive page elements of a webpage associated with the user action; and (iv) a user action time of the user action that may describe a captured time of the corresponding user action, and/or the like.

The term “multi-tenant execution” may refer to execution of a group of automated execution run data entities associated with a group of test automation tenants in a manner that is configured to enable each test automation tenant to execute corresponding automation execution run data entities without awareness that the test automation tenant is sharing a total agent pool associated with the multi-tenant execution with other test automation tenants. For example, multi-tenant execution of a group of automated execution run data entities may require that, given two or more test automation tenants associated with the group of automated execution run data entities, that at least one available automated testing execution agent in a total pool be allocated to each test automation tenant of the two or more test automation tenants. As another example, multi-tenant execution of a group of automated execution run data entities may require that, given n test automation tenants associated with the group of automated execution run data entities where n>=2, that 1/nth of available automated testing execution agents in a total agent pool be allocated to each test automation tenant of the two or more test automation tenants. As yet another example, multi-tenant execution of a group of automated execution run data entities may require that, given two or more test automation tenants associated with the group of automated execution run data entities, that the automated testing execution agents be allocated to the test automation tenants in a manner that is configured to minimize a count of test automation tenants in a throttled tenant subset, where a test automation tenant may be in a throttled tenant subset if the allocated agent subset for the test automation tenant fails to satisfy a minimum agent allocation requirement for the test automation tenant.

The term “test automation tenant” may refer to a data construct that is configured to describe a property of an automated execution run data entity that is used to allocate automated testing execution agents to the automated execution run data entity in a manner that is configured to meet the requirements of multi-tenant execution of a group of automated execution run data entities that comprise the automated execution run data entity. For example, a test automation tenant may describe/identify a customer identifier that is associated with a corresponding automated execution run data entity. In this example, each test automation tenant may be associated with a set of user profiles that are in turn associated with the noted customer identifier. In some embodiments, each test automation tenant is also associated with a per-tenant execution run queue that describes a prioritization of the outstanding automated execution run data entities that are associated with the test automation tenant. As another example, a test automation tenant may describe a project identifier that is associated with a corresponding automated execution run data entity. In this example, allocating automated testing execution agents may be done in a manner that is configured to ensure that all projects associated with the same customer identifier get allocated a number of automated testing execution agents that corresponds to a minimum agent allocation requirement for the customer identifier. As yet another example, a test automation tenant may describe a team identifier that is associated with a corresponding automated execution run data entity. In this example, allocating automated testing execution agents may be done in a manner that is configured to ensure that all teams associated with the same customer identifier get allocated a number of automated testing execution agents that corresponds to a minimum agent allocation requirement for the customer identifier.

The term “automated testing execution agent” may refer to a data construct that is configured to describe a process for executing test automation operations associated with an allocated automated execution run data entity. In some embodiments, a single automated testing executing agent can only execute one execution run data entity at each time. In some embodiments, the allocated automated execution run data entity associated with an automated testing execution agent may include one of the following: one user-interface-based test case data entity that describes testing user-interface-related features via user-interface-related actions, and one or more application-programming-interface test case data entities each describing testing application programming interface (API) functionalities. In some embodiments, to execute a set of test automation operations for an allocated execution run data entity, the automated testing execution agent executes a required number of workflow playback operations based at least in part on an ordered sequence of automated testing workflow steps for an automated testing workflow data entity of the allocated automated execution run data entity until a terminal workflow playback operation that is associated with a target automated testing workflow step that is a first automated testing workflow step with a negative success indicator. In some embodiments, a web server computing entity performs a workflow playback operation for each automated testing workflow step until a first automated testing workflow step that is associated with an interactive page element that cannot be located within a corresponding webpage and/or with respect to which a captured user interaction associated with the automated testing workflow step cannot successfully be performed. In some embodiments, each automated testing execution agent is a standalone execution package (e.g., a Docker container) that comprises the code, runtime configurations, system tools, system libraries, and settings associated with a corresponding automated testing workflow data entity. In some embodiments, an automated testing execution agent may execute execution run data entities in either or both of conventional web browsers and headless web browsers.

The term “total agent pool” may refer to a data construct that is configured to describe all of the automated testing execution agents associated with a test automation platform. In some embodiments, the total agent pool comprises a set of pre-generated automated testing execution agents that can be allocated to particular automated execution run data entities in accordance with an available agent allocation scheme, as further described below. In some embodiments, the total agent pool are dynamically generated by an agent management routine based at least in part on determinations made by the agent management routine about how to process a set of automated execution run data entities as determined based at least in part on a set of per-tenant execution run queues. In some embodiments, each automated testing execution agent may be allocated to an automated testing tenant. In this way, the total agent pool may at each time be divided into the following disjoint n+1 subsets: an allocated agent subset for each test automation tenant of n test automation tenants and an available agent subset that comprises those automated testing execution agents that are not allocated to any test automation tenants. For example, if at a particular time the total agent pool comprises a first automated testing execution agent A1 that is allocated to a first test automation tenant T1, a second automated testing execution agent A2 that is allocated to T1, a third automated testing execution agent A3 that is allocated to a second test automation tenant T2, a fourth automated testing execution agent A4 that is allocated to a second test automation tenant T3, and a fifth automated testing execution agent A5 that is not allocated to any test automation tenants, then the total agent pool may be divided into the following disjoint subsets: {A1, A2} for T1, {A3} for T2, {A4} for T3, and {A5} as the available agent subset. In some embodiments, if no automated testing execution agents are allocated to a particular test automation tenant, then the allocated agent subset for the test automation tenant may be an empty set. In some embodiments, if all automated execution agents in the total agent pool are allocated to test automation tenants, then the available agent subset for the test automation platform may be an empty set. In some embodiments, subsequent to execution of execution run data entities by particular automated testing execution agents, the automated testing execution agents are reset (e.g., to ensure there is no overlap of data across execution runs) and added to the available agent subset of total agent pool. In some embodiments, subsequent to execution of execution run data entities by particular automated testing execution agents, the placeholders for the automated testing execution agents (e.g., standalone execution packages such as Docker containers) are added to the available agent subset of the available agent subset. In some embodiments, when automated testing execution agents are standalone execution packages, the total agent pool includes placeholders of the standalone execution packages. In some embodiments, subsequent to execution of execution run data entities by particular automated testing execution agents, the automated testing execution agents (automated testing execution agents that are not standalone execution packages) are shut down to minimize their operational load on the system. In some embodiments, subsequent to execution of execution run data entities by particular automated testing execution agents, a proposed system may determine an expected number of upcoming execution run data entities in an upcoming timeframe based on one or more per-tenant execution run queues, and subsequently determine whether to shut down each of the automated testing execution agents based on applying a cost optimization model to the expected number of upcoming execution run data entities.

The term “minimum agent allocation requirement” may refer to a data construct that is configured to describe a minimum count of automated testing execution agents that should optimally be allocated to a particular test automation tenant if the per-agent execution run queue for the particular test automation tenant describes at least one outstanding automated execution run data entity. For example, the minimum agent allocation requirement for a particular test automation tenant may describe how at least one automated testing execution agent should optimally be allocated to the particular test automation tenant if the per-agent execution run queue for the particular test automation tenant describes at least one outstanding automated execution run data entity. As another example, the minimum agent allocation requirement for a particular test automation tenant may describe how at least n automated testing execution agents should optimally be allocated to the particular test automation tenant if the per-agent execution run queue for the particular test automation tenant describes at least one outstanding automated execution run data entity. As another example, the minimum agent allocation requirement for a particular test automation tenant may describe that, given m outstanding automated execution run data entities in the per-agent execution run queue for the particular test automation tenant, at least └m/d┘ automated testing execution agents that should optimally be allocated to the particular test automation tenant, where d may be a tunable delay parameter for the particular test automation tenant. As yet another example, the minimum agent allocation requirement for a particular test automation tenant may describe that, given m outstanding automated execution run data entities in the per-agent execution run queue for the particular test automation tenant, at least ┌m/d┐ automated testing execution agents that should optimally be allocated to the particular test automation tenant, where d may be a tunable delay parameter for the particular test automation tenant. In some embodiments, the minimum agent allocation requirement may be shared across all test automation tenants associated with a test automation platform or across a subset “tier” of test automation tenants associated with a test automation platform. In some embodiments, tunable delay parameters (as described above) may be shared across all test automation tenants associated with a test automation platform or across a subset “tier” of test automation tenants associated with a test automation platform.

The term “throttled tenant subset” may refer to a data construct that is configured to describe a subset of test automation tenants associated with a test automation platform, where allocated agent subset for a test automaton tenant in the throttled tenant subset fails to satisfy a minimum agent allocation requirement for the test automaton tenant. For example, if no test automation execution agents are allocated to a test automation tenant whose minimum agent allocation requirement describes that at least one automated testing execution agent should optimally be allocated to the particular test automation tenant if the per-agent execution run queue for the particular test automation tenant describes at least one outstanding automated execution run data entity, then the test automation tenant may be in the throttled tenant subset. As another example, if less than n test automation execution agents are allocated to a test automation tenant whose minimum agent allocation requirement describes that at least n automated testing execution agents should optimally be allocated to the particular test automation tenant if the per-agent execution run queue for the particular test automation tenant describes at least one outstanding automated execution run data entity, then the test automation tenant may be in the throttled tenant subset. In some embodiments, multi-tenant execution of a group of automated execution run data entities may require that, given two or more test automation tenants associated with the group of automated execution run data entities, that the automated testing execution agents be allocated to the test automation tenants in a manner that is configured to minimize a count of test automation tenants in the throttled tenant subset.

The term “available agent allocation scheme” may refer to a data construct that is configured to describe recommended allocations of automated testing execution agents to test automation tenants. In some embodiments, an available agent allocation scheme describes a set of agent-tenant allocation recommendations, where each agent-tenant allocation recommendation associates an automated testing execution agent in the available agent subset with a test automation tenant in the throttled tenant subset. In some embodiments, determining an available agent allocation scheme comprises generating one or more agent-tenant allocation recommendations in a manner that is configured to minimize a count of test automation tenants in the throttled tenant subset. In some embodiments, determining an available agent allocation scheme comprises generation one or more agent-tenant allocation recommendations in a manner that is configured to minimize a count of test automation tenants whose allocated agent subset is an empty set. In some embodiments, once an available agent allocation scheme is determined, a web server computing entity executes one or more agent allocation operations based at least in part on the available agent allocation scheme.

The term “per-tenant execution run queue” may refer to a data construct that is configured to describe a prioritization of automated testing execution agents associated with a corresponding automated testing tenant. In some embodiments, the defined prioritization of the per-tenant execution run queue may be determined based at least in part on time of placement of automated execution run data entities in the per-tenant execution run queue, for example in a manner such that an earlier-placed automated execution run data entity is removed prior to a later-placed automated execution run data entity. In some embodiments, an agent management routine is configured to periodically query the group of per-tenant agent run queues to identify an internally-executed subset of the group of automated execution run data entities and generate the group of automated testing execution agents based at least in part on the internally-executed subset. Examples of per-tenant execution queues comprise per-tenant execution queues generated using Amazon Simple Queue Service as well as custom per-tenant execution queues generated using relational database models.

The term “automated testing workflow data entity” may refer to a data construct that is configured to describe a sequence of web-based actions that may be executed to generate an automated testing operation associated with a software test that is configured to be executed to achieve a particular software testing objective, such as to exercise a particular program path or to verify compliance with a specific operational requirement. For example, the automated testing workflow data entity may describe a sequence of webpages associated with a software testing operation, where each webpage may in turn be associated with a set of automated testing workflow steps. The sequence of webpages and their associated automated testing workflow steps may then be used to generate automation scripts for the software testing operation, where the automation script may be executed by an execution agent in order to execute the software testing operation and generate a software testing output based at least in part on a result of the execution of the automation script. In some embodiments, an automated testing workflow data entity is determined based at least in part on a test case data entity for the corresponding software testing operation, where the test case data entity may describe data associated with a test case, where the test case may in turn describe a specification of the inputs, execution conditions, testing procedure, and expected results that define a test that is configured to be executed to achieve a particular software testing objective, such as to exercise a particular program path or to verify compliance with a specific operational requirement.

The term “automated testing workflow step” may refer to a data construct that is configured to describe a user action required by a software testing operation associated with a corresponding automated testing workflow data entity, where the user action may be executed with respect to an interactive page element of a webpage associated with a captured page image of the corresponding automated testing workflow data entity. In some embodiments, an automated testing workflow step may be associated with: (i) an image region of the corresponding captured page image that corresponds to the interactive page element for the automated testing workflow step; and (ii) a workflow step action feature element that comprises one or more action features of the user action associated with the automated testing workflow step. For example, if an automated testing workflow step corresponds to the user action of selecting a particular button on a particular webpage, the automated testing workflow step may describe data corresponding to an image region of a captured image for the particular webpage that corresponds to (e.g., is defined in relation to) a location of the particular button on the particular webpage. In the noted example, the automated testing workflow step may describe data associated with action features of a user action that may be used to generate a workflow step action feature element for the automated testing workflow step. An action feature of a user action may describe any property of a user action that is configured to change a state and/or a value of an interactive page element within a webpage. Examples of action features for a user action include: (i) a user action type of the user action that may describe a general input mode of user interaction with the interactive page element associated with the user action; (ii) a user input value of the user action that may describe a value provided by the user to an interactive page element; (iii) a user action sequence identifier of the user action that may describe a temporal order of the user action within a set of sequential user actions executed with respect to interactive page elements of a webpage associated with the user action; and (iv) a user action time of the user action that may describe a captured time of the corresponding user action, and/or the like.

The term “workflow playback operation” may refer to a data construct that is configured to describe an operation that is configured to perform a captured user action associated with a corresponding automated testing workflow step within a web environment of the automated testing workflow data entity that comprises the corresponding automated testing workflow step. In some embodiments, executing a workflow playback operation comprises: (i) identifying a workflow simulation web environment for a webpage associated with the automated testing workflow step for the workflow playback operation; (ii) generating a modified web environment state for the automated testing workflow step by modifying a web environment state of the workflow simulation web environment based at least in part on a captured user interaction for the automated testing workflow step; and (iii) generating the success indicator for the workflow playback operation based at least in part on the modified web environment state for the automated testing workflow step.

The term “session data entity” may refer to an electronically-stored data construct that is configured to describe recorded/captured data associated with a set of user interactions in relation to a set of webpages. For example, the session data entity may describe that an end user loads a first webpage, enters a text input in a first designated textbox on the first webpage, selects a first designated checkbox on the first webpage, selects a first designated button on the first webpage to proceed to a second webpage, selects a set of items from a first designated list box on the second webpage, selects a first designated radio button from a first designated set of related radio buttons on the second webpage, and dragging an icon on the second webpage from a first location to a second location. In the noted example, a software component (e.g., a web browser extension) may be configured to detect and record a set of user interactions by an end user across the two webpages in order to generate the session data entity. Thus, the session data entity may describe: (i) a sequence of webpages across which user interactions have been captured, and (ii) for each webpage of the sequence of webpages, a set of user interactions performed in relation to the noted webpage. For example, for the exemplary session data entity described above, the session data entity may describe: (i) a sequence of webpages that describes that the first webpage was visited first and the second webpage was subsequently visited, (ii) for the first webpage, the user interactions corresponding to entering a text input in the first designated textbox on the first webpage, selecting the first designated checkbox on the first webpage, and selecting the first designated button on the first webpage, and (iii) for the second webpage, the user interactions corresponding to selecting the first designated radio button from the first designated set of related radio buttons on the second webpage and dragging and dropping the icon on the second webpage. In some embodiments, the session data entity comprises (a) an ordered sequence of a plurality of captured page images that (i) were captured during the session, and (ii) correspond to a plurality of webpages visited by the end user during the session, and (b) a plurality of captured user interactions performed by the end user while interacting with the plurality of webpages. In some embodiments, to generate a session data entity, a screen capture component collects the various metadata for each interactive page element, such as element ID, element parent ID, element sibling IDs, the absolute and relative xpath of the element, the element name, the element type, etc., where at least some of these metadata features may be used create multiple strategies which can be used to locate the interactive page element upon playback of the session data entity.

The term “captured page image” may refer to a data construct that is configured to describe an image file that depicts a screenshot of a corresponding webpage at a particular point in time during a captured sequence of user interactions with the corresponding webpage, where the captured sequence of user interactions may be described by a session data entity that comprises the captured webpage. In some embodiments, prior to loading a subsequent webpage after a current webpage during a session of an end user that includes visiting a sequence of ordered webpages, a software component (e.g., a web browser extension) generates a screenshot of the current webpage and uses the generated screenshot as a captured page image for the current webpage. As such, in the noted embodiments, the captured page image depicts a visual state of the current webpage after all of the corresponding user interactions associated with the current webpage are performed. In some embodiments, immediately subsequent to successfully loading a current webpage during a session of an end user that includes visiting a sequence of ordered webpages, a software component (e.g., a web browser extension) generates a screenshot of the current webpage and uses the generated screenshot as a captured page image for the current webpage. As such, in the noted embodiments, the captured page image depicts a visual state of the current webpage before all of the corresponding user interactions associated with the current webpage are performed.

The term “captured user interaction” may refer to an electronically-stored data construct that is configured to describe a recorded/captured user action with respect to a segment of a webpage, where the captured user interaction may be described by a session data entity corresponding to a recorded/captured session that included performing the corresponding user action associated with the captured user interaction. In some embodiments, a captured user interaction describes: (i) an associated interactive page element within a corresponding webpage with respect to which the corresponding user action was performed during the recorded/captured session, (ii) a user action type of the corresponding user action with respect to the associated interactive page element within the corresponding webpage, and (iii) if the corresponding user action type of the corresponding user action requires inputting a user input value, the user input value entered as part of the corresponding user action associated with the captured user interaction. For example, consider a recorded/captured session that included the user action of selecting a button within a webpage. In the noted example, the captured user interaction corresponding to the noted action may describe: (i) the button as the interactive page element corresponding to the captured user interaction, and (ii) selecting (i.e., clicking) as the user action type of the captured user interaction. As another example, consider a recorded/captured session that included the user action of typing “pshoghi” into a username textbox. In the noted example, the captured user interaction corresponding to the noted user action may describe: (i) the username textbox as the interactive page element corresponding to the captured user interaction, (ii) typing (i.e., inputting text) as the user action type corresponding to the captured user interaction, and (iii) because the user action type of typing requires a user input value, the text input value “pshoghi” as the user input value for the captured user interaction. In some embodiments, a captured user interaction is associated with (i) a captured page image, (ii) an interactive page element, and (ii) a set of action features. The captured page image for a captured user interaction may describe an image of a corresponding webpage with respect to which a user action corresponding to the captured user interaction is performed, while an interactive page element may describe an element (e.g., an interactive page element, a Hypertext Markup Language (HTML) element, and/or the like) of the corresponding webpage, where the user action corresponding to the captured user interaction is performed exclusively by changing a state and/or a value of the particular element. An action feature of a captured user interaction may describe any property of a user action intended to change a state and/or a value of an interactive page element, where the user action is recorded/captured using a captured user interaction in a session data entity. Examples of action features for a captured user interaction include (i) a user action type of a user action associated with the captured user interaction that may describe a general mode of user interaction with an interactive page element which may be defined based at least in part on an interactive page element type of the interactive page element, (ii) a user input value of a user action associated with the captured user interaction that may describe a finalized (rather than intermediate) value of a user action with respect to an interactive page element, (iii) a user action sequence identifier of a user action associated with the captured user interaction that may describe a temporal order of the user action within a set of sequential user actions performed with respect to interactive page elements of a webpage associated with the user action, (iv) a user action time of a user action associated with the captured user interaction that may describe a captured time of the corresponding user action, and/or the like. In some embodiments, a captured user action may only be generated upon detecting a qualified user action from a set of qualified user actions (e.g., a set that may exclude at least one of the click action on the field, the shift+key action for upper case, and the field leave action).

### Computer Program Products, Methods, and Computing Entities

Embodiments of the present invention may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware framework and/or operating system platform. A software component comprising assembly language instructions may require conversion into executable machine code by an assembler prior to execution by the hardware framework and/or platform. Another example programming language may be a higher-level programming language that may be portable across multiple frameworks. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

A computer program product may include non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage median include all computer-readable media (including volatile and non-volatile media).

In one embodiment, a non-volatile computer-readable storage medium may include a floppy disk, flexible disk, hard disk, solid-state storage (SSS) (e.g., a solid state drive (SSD), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present invention may also be implemented as methods, apparatuses, systems, computing devices, computing entities, and/or the like. As such, embodiments of the present invention may take the form of an apparatus, system, computing device, computing entity, and/or the like executing instructions stored on a computer-readable storage medium to execute certain steps or operations. Thus, embodiments of the present invention may also take the form of an entirely hardware embodiment, an entirely computer program product embodiment, and/or an embodiment that comprises combination of computer program products and hardware executing certain steps or operations.

Embodiments of the present invention are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatuses, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be executed sequentially such that one instruction is retrieved, loaded, and executed at a time. In some exemplary embodiments, retrieval, loading, and/or execution may be executed in parallel such that multiple instructions are retrieved, loaded, and/or executed together. Thus, such embodiments can produce specifically-configured machines executing the steps or operations specified in the block diagrams and flowchart illustrations. Accordingly, the block diagrams and flowchart illustrations support various combinations of embodiments for executing the specified instructions, operations, or steps.

### Exemplary System Framework

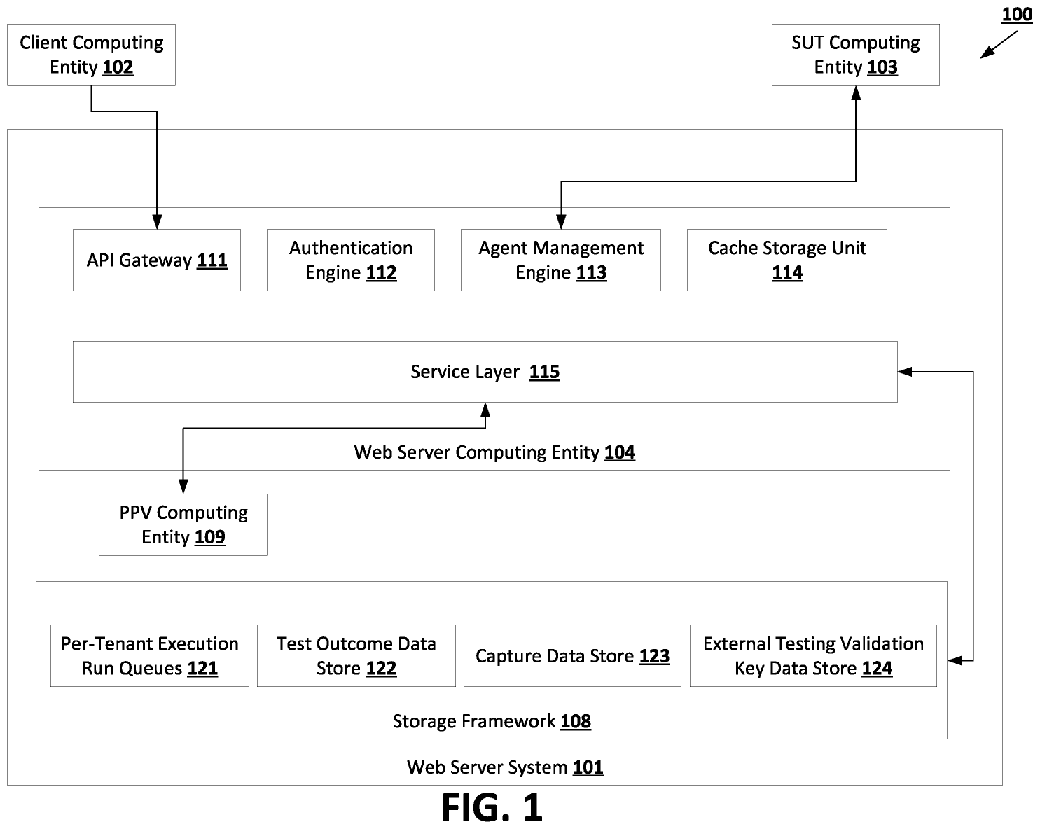

FIG. 1 depicts an architecture 100 for managing multi-tenant execution of a group of automated execution run data entities associated with a plurality of test automation tenants. The architecture 100 that is depicted in FIG. 1 includes the following: (i) a web server system 101 comprising a web server computing entity 104, a storage framework 108, and a post-production validation (PPV) computing entity 109; (ii) one or more client computing entities such as the client computing entity 102; and (iii) and one or more system under test (SUT) computing entities such as the SUT computing entity 103.

In some embodiments, the web server computing entity 104 is configured to: (i) receive execution run data entities from the client computing entities and execute software testing operations corresponding to the execution run data entities by interacting with the SUT computing entities 103; and (ii) validate software testing platforms by installing the software testing platforms on the PPV computing entity 109 and checking whether the installed software testing platforms comply with platform requirements (e.g., customer-specified platform requirements). The web server computing entity 104 may be configured to receive execution run data entities from the client computing entities using the application programming (API) gateway 111 that may be an Amazon API Gateway. The web server computing entity 104 may further be configured to validate execution run data entities using the Authentication Engine 112, which may be an Amazon Web Services (AWS) Lambda Authentication Filter. The web server computing entity 104 may be further configured to execute software testing operations corresponding to execution run data entities by using automated testing execution agents generated and maintained by an agent management engine 113, where the agent management engine 113 may be configured to generate and maintain automated testing execution agents based at least in part on autoscaling routines and agent throttling concepts discussed herein.

The web server computing entity 104 may be further configured to maintain a cache storage unit 114 (e.g., a Redis cache) to maintain execution data associated with executing software testing operations corresponding to the execution run data entities by interacting with the SUT computing entities 103 and/or execution data associated with validating software testing platforms by installing the software testing platforms on the PPV computing entity 109 and checking whether the installed software testing platforms comply with platform requirements (e.g., customer-specified platform requirements).

The web server computing entity 104 may in some embodiments comprise a service layer 115, where the service layer 115 is comprised to maintain at least one of the following in the storage framework 108: (i) a set of per-tenant execution run queues 121 (as further described below); (ii) a test outcome data store 122 storing data describing which software testing operations have succeeded or failed; (iii) a capture data store 123 storing data related to captured page images generated while performing software testing operations; and (iv) an external testing validation key data store 124 storing external testing validation keys for external automated testing execution agents.

### Exemplary Web Server Computing Entity

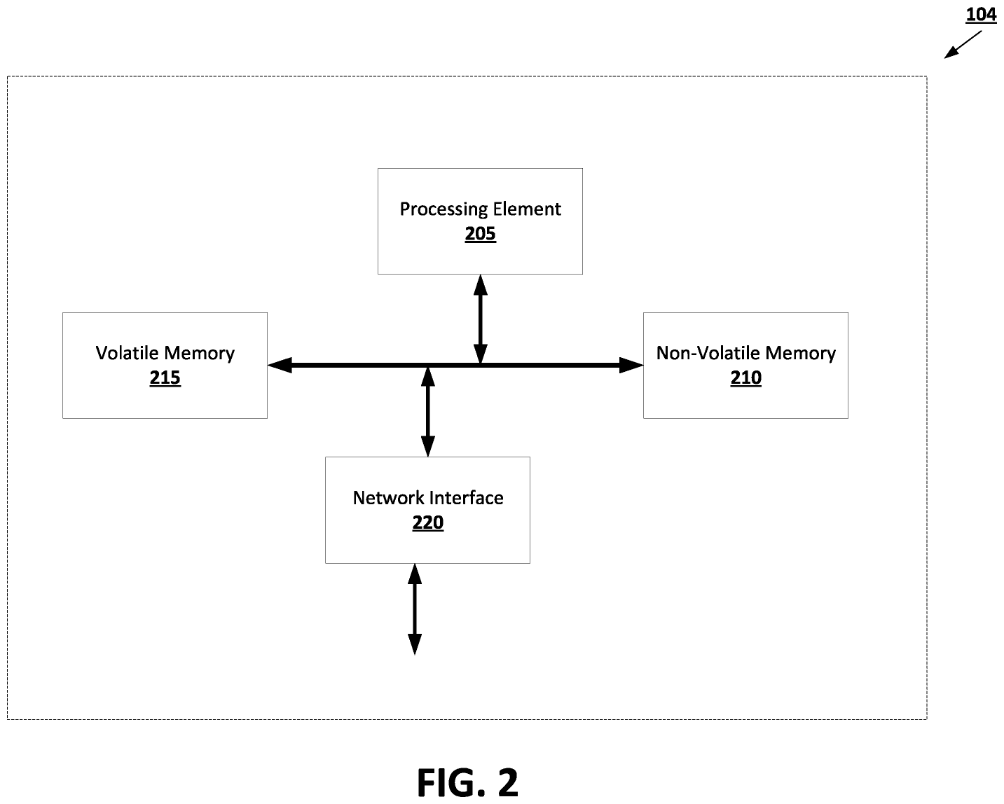

FIG. 2 provides a schematic of a web server computing entity 104 according to one embodiment of the present invention. In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to execute the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes can be executed on data, content, information, and/or similar terms used herein interchangeably. While FIG. 2 is described with reference to the web server computing entity 104, a person of ordinary skill in the relevant technology will recognize that the depicted architecture can be used in relation to SUT computing entities and PPV computing entities.

As indicated, in one embodiment, the web server computing entity 104 may also include one or more communications interfaces 220 for communicating with various computing entities, such as by communicating data, content, information, and/or similar terms used herein interchangeably that can be transmitted, received, operated on, processed, displayed, stored, and/or the like.

As shown in FIG. 2, in one embodiment, the web server computing entity 104 may include, or be in communication with, one or more processing elements 205 (also referred to as processors, processing circuitry, and/or similar terms used herein interchangeably) that communicate with other elements within the web server computing entity 104 via a bus, for example. As will be understood, the processing element 205 may be embodied in a number of different ways.

For example, the processing element 205 may be embodied as one or more complex programmable logic devices (CPLDs), microprocessors, multi-core processors, coprocessing entities, application-specific instruction-set processors (ASIPs), microcontrollers, and/or controllers. Further, the processing element 205 may be embodied as one or more other processing devices or circuitry. The term circuitry may refer to an entirely hardware embodiment or a combination of hardware and computer program products. Thus, the processing element 205 may be embodied as integrated circuits, application specific integrated circuits (ASICs), field programmable gate arrays (FPGAs), programmable logic arrays (PLAs), hardware accelerators, other circuitry, and/or the like.

As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of executing steps or operations according to embodiments of the present invention when configured accordingly.

In one embodiment, the web server computing entity 104 may further include, or be in communication with, non-volatile media (also referred to as non-volatile storage, memory, memory storage, memory circuitry and/or similar terms used herein interchangeably). In one embodiment, the non-volatile storage or memory may include one or more non-volatile storage or memory media 210, including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

As will be recognized, the non-volatile storage or memory media may store databases, database instances, database management systems, data, applications, programs, program modules, scripts, source code, object code, byte code, compiled code, interpreted code, machine code, executable instructions, and/or the like. The term database, database instance, database management system, and/or similar terms used herein interchangeably may refer to a collection of records or data that is stored in a computer-readable storage medium using one or more database models, such as a hierarchical database model, network model, relational model, entity-relationship model, object model, document model, semantic model, graph model, and/or the like.

In one embodiment, the web server computing entity 104 may further include, or be in communication with, volatile media (also referred to as volatile storage, memory, memory storage, memory circuitry and/or similar terms used herein interchangeably). In one embodiment, the volatile storage or memory may also include one or more volatile storage or memory media 215, including, but not limited to, RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like.

As will be recognized, the volatile storage or memory media may be used to store at least portions of the databases, database instances, database management systems, data, applications, programs, program modules, scripts, source code, object code, byte code, compiled code, interpreted code, machine code, executable instructions, and/or the like being executed by, for example, the processing element 205. Thus, the databases, database instances, database management systems, data, applications, programs, program modules, scripts, source code, object code, byte code, compiled code, interpreted code, machine code, executable instructions, and/or the like may be used to control certain aspects of the operation of the web server computing entity 104 with the assistance of the processing element 205 and operating system.

As indicated, in one embodiment, the web server computing entity 104 may also include one or more communications interfaces 220 for communicating with various computing entities, such as by communicating data, content, information, and/or similar terms used herein interchangeably that can be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the web server computing entity 104 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the web server computing entity 104 may include, or be in communication with, one or more input elements, such as a keyboard input, a mouse input, a touch screen/display input, motion input, movement input, audio input, pointing device input, joystick input, keypad input, and/or the like. The web server computing entity 104 may also include, or be in communication with, one or more output elements (not shown), such as audio output, video output, screen/display output, motion output, movement output, and/or the like.

### Exemplary Client Computing Entity

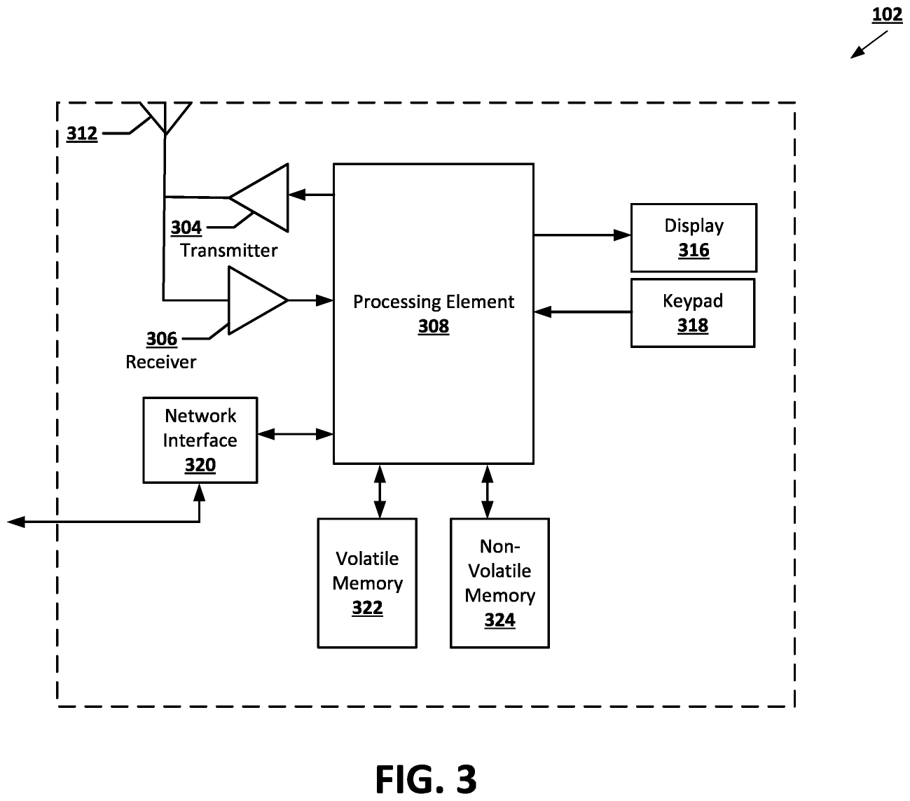

FIG. 3 provides an illustrative schematic representative of an client computing entity 102 that can be used in conjunction with embodiments of the present invention. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Client computing entities 102 can be operated by various parties. As shown in FIG. 3, the client computing entity 102 can include an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) that provides signals to and receives signals from the transmitter 304 and receiver 306, correspondingly.

The signals provided to and received from the transmitter 304 and the receiver 306, correspondingly, may include signaling information/data in accordance with air interface standards of applicable wireless systems. In this regard, the client computing entity 102 may be capable of operating with one or more air interface standards, communication protocols, modulation types, and access types. More particularly, the client computing entity 102 may operate in accordance with any of a number of wireless communication standards and protocols, such as those described above with regard to the web server computing entity 104. In a particular embodiment, the client computing entity 102 may operate in accordance with multiple wireless communication standards and protocols, such as UMTS, CDMA2000, 1×RTT, WCDMA, GSM, EDGE, TD-SCDMA, LTE, E-UTRAN, EVDO, HSPA, HSDPA, Wi-Fi, Wi-Fi Direct, WiMAX, UWB, IR, NFC, Bluetooth, USB, and/or the like. Similarly, the client computing entity 102 may operate in accordance with multiple wired communication standards and protocols, such as those described above with regard to the web server computing entity 104 via a network interface 320.

Via these communication standards and protocols, the client computing entity 102 can communicate with various other entities using concepts such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The client computing entity 102 can also download changes, add-ons, and updates, for instance, to its firmware, software (e.g., including executable instructions, applications, program modules), and operating system.

According to one embodiment, the client computing entity 102 may include location determining aspects, devices, modules, functionalities, and/or similar words used herein interchangeably. For example, the client computing entity 102 may include outdoor positioning aspects, such as a location module adapted to acquire, for example, latitude, longitude, altitude, geocode, course, direction, heading, speed, universal time (UTC), date, and/or various other information/data. In one embodiment, the location module can acquire data, sometimes known as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data can be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data can be determined by triangulating the client computing entity's 102 position in connection with a variety of other systems, including cellular towers, Wi-Fi access points, and/or the like. Similarly, the client computing entity 102 may include indoor positioning aspects, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops) and/or the like. For instance, such technologies may include the iBeacons, Gimbal proximity beacons, Bluetooth Low Energy (BLE) transmitters, NFC transmitters, and/or the like. These indoor positioning aspects can be used in a variety of settings to determine the location of someone or something to within inches or centimeters.

The client computing entity 102 may also comprise a user interface (that can include a display 316 coupled to a processing element 308) and/or a user input interface (coupled to a processing element 308). For example, the user interface may be a user application, browser, user interface, and/or similar words used herein interchangeably executing on and/or accessible via the client computing entity 102 to interact with and/or cause display of information/data from the web server computing entity 104, as described herein. The user input interface can comprise any of a number of devices or interfaces allowing the client computing entity 102 to receive data, such as a keypad 318 (hard or soft), a touch display, voice/speech or motion interfaces, or other input device. In embodiments including a keypad 318, the keypad 318 can include (or cause display of) the conventional numeric (0-9) and related keys (#, *), and other keys used for operating the client computing entity 102 and may include a full set of alphabetic keys or set of keys that may be activated to provide a full set of alphanumeric keys. In addition to providing input, the user input interface can be used, for example, to activate or deactivate certain functions, such as screen savers and/or sleep modes.

The client computing entity 102 can also include volatile storage or memory 322 and/or non-volatile storage or memory 324, which can be embedded and/or may be removable. For example, the non-volatile memory may be ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. The volatile and non-volatile storage or memory can store databases, database instances, database management systems, data, applications, programs, program modules, scripts, source code, object code, byte code, compiled code, interpreted code, machine code, executable instructions, and/or the like to implement the functions of the client computing entity 102. As indicated, this may include a user application that is resident on the entity or accessible through a browser or other user interface for communicating with the web server computing entity 104 and/or various other computing entities.

In another embodiment, the client computing entity 102 may include one or more components or functionality that are the same or similar to those of the web server computing entity 104, as described in greater detail above. As will be recognized, these architectures and descriptions are provided for exemplary purposes only and are not limiting to the various embodiments.

In various embodiments, the client computing entity 102 may be embodied as an artificial intelligence (AI) computing entity, such as an Amazon Echo, Amazon Echo Dot, Amazon Show, Google Home, and/or the like. Accordingly, the client computing entity 102 may be configured to provide and/or receive information/data from a user via an input/output mechanism, such as a display, a camera, a speaker, a voice-activated input, and/or the like. In certain embodiments, an AI computing entity may comprise one or more predefined and executable program algorithms stored within an onboard memory storage module, and/or accessible over a network. In various embodiments, the AI computing entity may be configured to retrieve and/or execute one or more of the predefined program algorithms upon the occurrence of a predefined trigger event.

### Exemplary System Operations

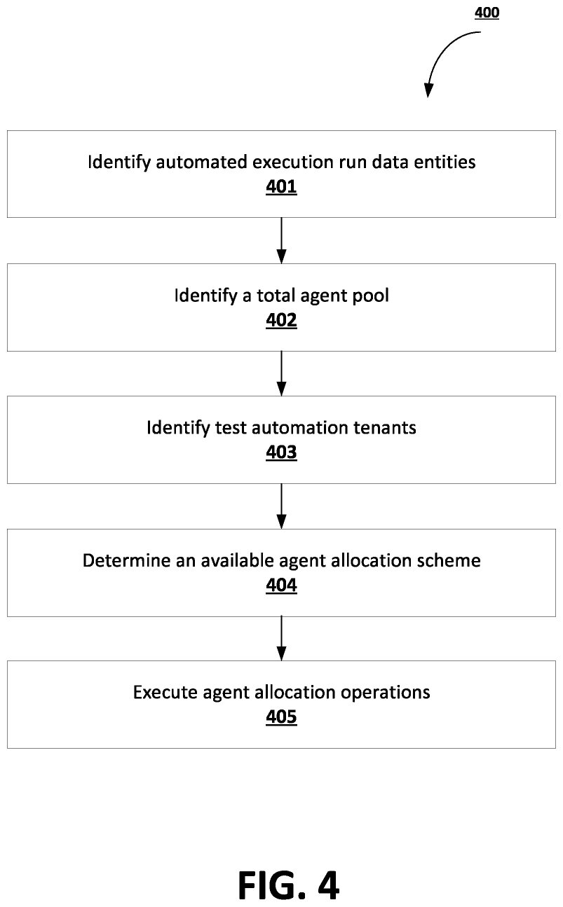

FIG. 4 is a flowchart diagram of an example process 400 for managing multi-tenant execution of a group of automated execution run data entities associated with a plurality of test automation tenants. Via the various steps/operations of the process 400, the web server computing entity 104 can enable execution of a group of automated execution run data entities associated with a group of test automation tenants in a manner that is configured to enable each test automation tenant to execute corresponding automation execution run data entities without awareness that the test automation tenant is sharing a total agent pool associated with the multi-tenant execution with other test automation tenants.

For example, multi-tenant execution of a group of automated execution run data entities may require that, given two or more test automation tenants associated with the group of automated execution run data entities, that at least one available automated testing execution agent in a total pool be allocated to each test automation tenant of the two or more test automation tenants. As another example, multi-tenant execution of a group of automated execution run data entities may require that, given n test automation tenants associated with the group of automated execution run data entities where n>=2, that 1/nth of available automated testing execution agents in a total agent pool be allocated to each test automation tenant of the two or more test automation tenants. As yet another example, multi-tenant execution of a group of automated execution run data entities may require that, given two or more test automation tenants associated with the group of automated execution run data entities, that the automated testing execution agents be allocated to the test automation tenants in a manner that is configured to minimize a count of test automation tenants in a throttled tenant subset, where a test automation tenant may be in a throttled tenant subset if the allocated agent subset for the test automation tenant fails to satisfy a minimum agent allocation requirement for the test automaton tenant. The process 400 that is depicted in FIG. 4 begins at step/operation 401 when the web server computing entity 104 identifies the group of automated execution run data entities. In some embodiments, each automated testing execution agent periodically (e.g., every ten seconds) pings a set of per-tenant execution run queues to determine any outstanding automated execution run data entities, and the web server computing entity 104 identifies the group of automated execution run data entities based at least in part on the results of the noted periodic pings. In some embodiments, an agent management routine (e.g., an agent management process running on the web server computing entity 104) is configured to periodically ping a set of per-tenant execution run queues to determine any outstanding automated execution run data entities, and the web server computing entity 104 identifies the group of automated execution run data entities based at least in part on the results of the noted periodic pings.

In some embodiments, an execution run data entity describes a defined execution of an execution plan data entity (as the term is defined above), such as a defined automated execution of an execution plan data entity. In some embodiments, when an execution run data entity describes an automated execution of an execution plan data entity, the execution run data entity is referred to herein as an “automated execution run data entity.” In some embodiments, an execution run data entity is determined based at least in part on a set of execution run definition parameters for the execution run data entity, such as an execution run automation parameter for the execution run data entity that describes whether the execution run data entity is an automated execution run data entity; an execution run scheduling parameter for the execution run data entity that describes whether the execution run data entity should be executed once, periodically (e.g., in accordance with a defined periodicity), or in an on-demand manner as demanded by end users; an execution run parallelization parameter for the execution run data entity that describes whether the execution run data entity should be performed sequentially or in parallel; and an execution run web environment parameter for the execution run data entity that describes the Uniform Resource Locator (URL) for a base (i.e., starting) webpage of the execution run data entity.

In some embodiments, the group of automated execution run data entities are determined based at least in part on a group of per-tenant execution run queues, and each per-tenant execution run queue is associated with a test automation tenant of the plurality of test automation tenants. In some of the noted embodiments, a per-tenant execution run queue describes a prioritization of automated testing execution agents associated with a corresponding automated testing tenant. In some embodiments, the defined prioritization of the per-tenant execution run queue may be determined based at least in part on time of placement of automated execution run data entities in the per-tenant execution run queue, for example in a manner such that an earlier-placed automated execution run data entity is removed prior to a later-placed automated execution run data entity. In some embodiments, an agent management routine is configured to periodically query the group of per-tenant agent run queues to identify an internally-executed subset of the group of automated execution run data entities and generate the group of automated testing execution agents based at least in part on the internally-executed subset. Examples of per-tenant execution queues comprise per-tenant execution queues generated using Amazon Simple Queue Service as well as custom per-tenant execution queues generated using relational database models.

At step/operation 402, the web server computing entity 104 identifies a total agent pool comprising a group of automated testing execution agents. In some embodiments, the total agent pool describes all of the automated testing execution agents associated with a test automation platform. In some embodiments, the total agent pool comprises a set of pre-generated automated testing execution agents that can be allocated to particular automated execution run data entities in accordance with an available agent allocation scheme, as further described below. In some embodiments, the total agent pool are dynamically generated by an agent management routine based at least in part on determinations made by the agent management routine about how to process a set of automated execution run data entities as determined based at least in part on a set of per-tenant execution run queues. In some embodiments, each automated testing execution agent may be allocated to an automated testing tenant. In this way, the total agent pool may at each time be divided into the following disjoint n+1 subsets: an allocated agent subset for each test automation tenant of n test automation tenants and an available agent subset that comprises those automated testing execution agents that are not allocated to any test automation tenants. For example, if at a particular time the total agent pool comprises a first automated testing execution agent A1 that is allocated to a first test automation tenant T1, a second automated testing execution agent A2 that is allocated to T1, a third automated testing execution agent A3 that is allocated to a second test automation tenant T2, a fourth automated testing execution agent A4 that is allocated to a second test automation tenant T3, and a fifth automated testing execution agent A5 that is not allocated to any test automation tenants, then the total agent pool may be divided into the following disjoint subsets: {A1, A2} for T1, {A3} for T2, {A4} for T3, and {A5} as the available agent subset. In some embodiments, if no automated testing execution agents are allocated to a particular test automation tenant, then the allocated agent subset for the test automation tenant may be an empty set. In some embodiments, if all automated execution agents in the total agent pool are allocated to test automation tenants, then the available agent subset for the test automation platform may be an empty set. In some embodiments, the total number of automated testing execution agents spawned at each time may be defined based on a static value that requires spawning X automated testing execution agents at each time. In some embodiments, the total number of automated testing execution agents spawned at each time may be defined based on a dynamic value that requires spawning X automated testing execution agents at each time, where X may be determined based on the operational load on a test automation platform and/or based on a number of outstanding execution run data entities in per-tenant execution run queues. In some embodiments, if an execution run contains less than or equal to N (e.g., 500) test case data entities, then a number of automated testing execution agents sufficient to run all of the test case data entities in parallel are spawn; however, if an execution run contains more than N test case data entities, then N automated testing execution agents are spawn to enable parallel execution agents of N of the test case data entities, and thus a subset of the test case data entities are not run in parallel with the original N test case data entities.

While various embodiments of the present invention describe determining available agent allocation schemes for a single total agent pool, a person of ordinary skill in the relevant technology will recognize that the disclosed techniques can be used to determine available agent allocation scheme across multiple total agent pools. For example, consider a scenario in which 500 automated testing execution agents are being used by a first test automation tenant in the US region, and a second test automation tenant decides to execute a run in the Australia region, a proposed system may spawn and reallocate 250 of the 500 automated testing execution agents in the Australia region for the second test automation tenant. In this scenario, the available agent allocation scheme may allocate 250 automated testing execution agents in a total agent pool for the US region to the first test automation tenant and 250 automated testing execution agents in a total agent pool for the Australia region to the second test automation tenant.

In some embodiments, the total agent pool includes automated testing execution agents that have finished executing execution run data entities as well as newly-spawn executing execution run data entities. In some embodiments, often it may take very little time, to run test case data entities, such as 1 or 2 minutes for smaller test case data entities. In some of the noted embodiments, automated testing execution agents are spawn in groups or batches of 20 to 50 at a time. In some embodiments, once an automated testing execution agent is spawn and comes online, the proposed system rechecks the needed number of agents relative what is currently available and spawn more automated testing execution agents as necessary. Because of this batching, the proposed system may never need to spawn automated testing execution agents equal to the number of all outstanding test case data entities.

For example, consider a scenario in which the proposed system is configured to run 500 tests within a single execution run data entity. If there are only 5 automated testing execution agents running in the pool, the proposed system may begin executing 5 of the 500 test case data entities, and spawn 20 more automated testing execution agents, which may take about 5 minutes to fully come online. In that 5 minute time, the first 5 test case data entities will likely have finished, and the newly spawned automated testing execution agents will have begun executing test case data entities, within that first spawn window. Thus, it possible that, by the time the proposed system checks to see if more automated testing execution agents are needed, in reality, such a need may have been addressed by those automated testing execution agents that have finished their execution runs.

In some embodiments, an automated testing execution agent is configured to execute a process for executing test automation operations associated with an allocated automated execution run data entity. In some embodiments, to execute a set of test automation operations for an allocated execution run data entity, the automated testing execution agent executes a required number of workflow playback operations based at least in part on an ordered sequence of automated testing workflow steps for an automated testing workflow data entity of the allocated automated execution run data entity until a terminal workflow playback operation that is associated with a target automated testing workflow step that is a first automated testing workflow step with a negative success indicator. In some embodiments, a web server computing entity performs a workflow playback operation for each automated testing workflow step until a first automated testing workflow step that is associated with an interactive page element that cannot be located within a corresponding webpage and/or with respect to which a captured user interaction associated with the automated testing workflow step cannot successfully be performed. In some embodiments, each automated testing execution agent is a standalone execution package (e.g., a Docker container) that comprises the code, runtime configurations, system tools, system libraries, and settings associated with a corresponding automated testing workflow data entity.

At step/operation 403, the web server computing entity 104 identifies a plurality of test automation tenants. In some embodiments, a test automation tenant may describe/identify a customer identifier that is associated with a corresponding automated execution run data entity. In this example, each test automation tenant may be associated with a set of user profiles that are in turn associated with the noted customer identifier. In some embodiments, each test automation tenant is also associated with a per-tenant execution run queue that describes a prioritization of the outstanding automated execution run data entities that are associated with the test automation tenant.

At step/operation 404, the web server computing entity 104 determines an available agent allocation scheme. The available agent allocation scheme may describe recommended allocations of automated testing execution agents to test automation tenants. In some embodiments, an available agent allocation scheme describes a set of agent-tenant allocation recommendations, where each agent-tenant allocation recommendation associates an automated testing execution agent in the available agent subset with a test automation tenant in the throttled tenant subset. In some embodiments, determining an available agent allocation scheme comprises generating one or more agent-tenant allocation recommendations in a manner that is configured to minimize a count of test automation tenants in the throttled tenant subset. In some embodiments, determining an available agent allocation scheme comprises generation one or more agent-tenant allocation recommendations in a manner that is configured to minimize a count of test automation tenants whose allocated agent subset is an empty set. In some embodiments, once an available agent allocation scheme is determined, a web server computing entity executes one or more agent allocation operations based at least in part on the available agent allocation scheme. In some embodiments, subsequent to execution of an execution run data entity by a particular automated testing execution agent, the automated testing execution agent is maintained for a defined amount of time (e.g., twenty minutes) before being shut down if during the defined amount of time the automated testing execution agent does not get allocated to an execution run data entity. In some of the noted embodiments, the lifecycle of a particular automated testing execution agent may include one or more execution runs followed by idle maintenance until the particular automated testing execution agent is shut down and removed.

In some embodiments, if a test automation tenant attempts to run two execution run data entities, and if, based on the available agent allocation scheme, immediate execution of one of the two execution run data entities is recommended but immediate execution of one of the two execution run data entities is not recommended, then the immediately-executed execution run data entity is selected in the following manner: (i) the execution run data entity that is scheduled sooner is selected as the immediately-executed execution run data entity, (ii) if both of the two execution run data entities are scheduled at the same time, the execution run data entity that has a fewer number of associated test case data entities is selected as the immediately-executed execution run data entity, and (iii) if both of the two execution run data entities are scheduled at the same time and have the same number of test case data entities, then the immediately-executed execution run data entity is selected using a custom logic, e.g., based on the execution run data entity the whose textual description (e.g., short description) has alphabetical precedence based on an alphabetical ordering scheme. In some embodiments, the described logic can be extended to any situation where a test automation tenant attempts to run n execution run data entities, where based on the available agent allocation scheme, immediate execution of m of the two execution run data entities is recommended but immediate execution of one of the n−m of the execution run data entities is not recommended, and where n<m.

In some embodiments, defined categories of execution run data entities are exempt from the available agent allocation schemes, e.g., are run without using automated testing execution agents in the total agent pool and/or are run without regard to ordering rules defined by the available agent allocation schemes. In some embodiments, the defined categories include worksheet execution run data entities. In some embodiments, a worksheet execution data entity is an execution run data entity that is generated based at least in part on filtering a planned test case subset for a previously-documented execution run data entity in accordance with an execution result data entity for the previously-documented execution run data entity and an execution result indicator for each candidate test case data entity in the planned test case subset. For example, in some embodiments, a worksheet execution run data entity may be generated by performing the following operations: (i) generating an eligible test case subset for the worksheet execution run data entity based at least in part on filtering the planned test case subset for the previously-documented execution run data entity, wherein filtering the planned test case subset is performed based at least in part on whether each execution result indicator for a candidate test case data entity in the planned test case subset is described by an execution result parameter for the previously-documented execution run data entity; and (ii) generating the worksheet execution run data entity based at least in part on an automation stage parameter value for each candidate test case data entity in the eligible test case subset. In some embodiments, a worksheet execution run data entity is stored by a web server computing entity in a storage platform associated with the web server computing entity only for a time period defined by an execution plan expiration parameter for the worksheet execution run data entity. In some embodiments, a worksheet execution run data entities can be associated with test case data entities that are not yet “ready for execution.” This may enable an automation engineer to test automation workflow data entities associated with an execution plan data entities before changing the status of the corresponding test case data entities from “ready for automation” to “ready for execution.” In some embodiments, the system will automatically update the automation stage parameter for a test case data entity to “ready for execution” upon a successful execution (e.g., test run) of the corresponding test case data entity within a worksheet execution run data entity. In some embodiments, test running worksheet execution run data entities enables running a group of test case data entities without creating execution plan data entities and/or without including the results of the test run among the execution result data for the executed test case data entities.

In some embodiments, available agent allocation schemes decrease average user wait-time that may come about as a result of nonoptimal testing resource allocation, thus reducing the computational load on test automation platforms. In this way, various embodiments of the present invention improve the computational efficiency and operational reliability of test automation platforms. For example, consider a scenario in which a user U1 associated with a test automation tenant T1 and a user U2 associated with a test automation tenant T2. In the absence of optimal testing resource allocation, one of U1 and U2 may have to wait while interacting with the test automation platform, which incurs unnecessary computational/operational costs on the noted test automation platform. By reducing this wait time, various embodiments of the present invention improve the computational efficiency and operational reliability of test automation platforms.

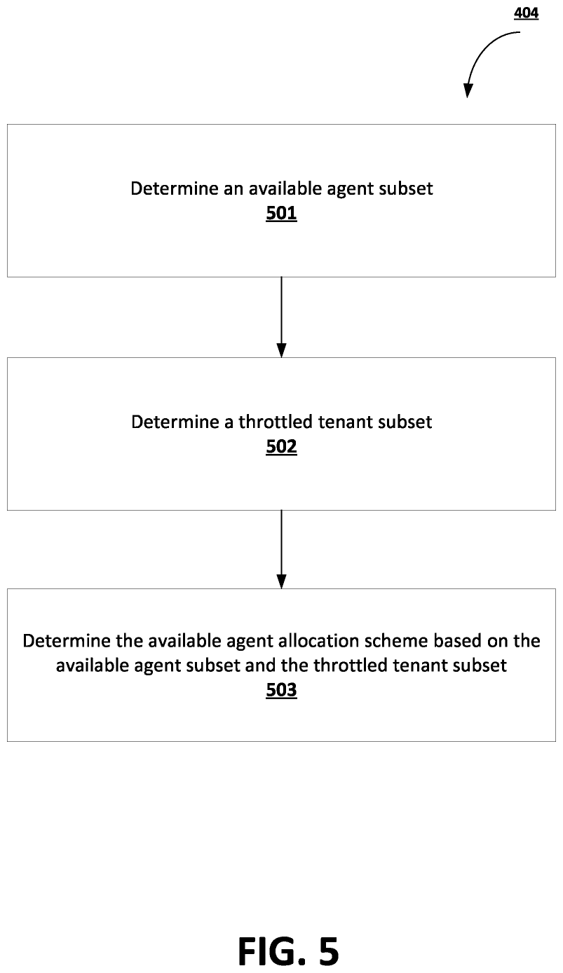

In some embodiments, step/operation 404 is performed in accordance with the process that is depicted in FIG. 5. The process that is depicted in FIG. 5 begins at step/operation 501 when the web server computing entity 104 identifies an available agent subset of the total agent pool. As described above, each automated testing execution agent may be allocated to an automated testing tenant. In this way, in some embodiments, the total agent pool may be divided into the following disjoint n+1 subsets: an allocated agent subset for each test automation tenant of n test automation tenants and an available agent subset that comprises those automated testing execution agents that are not allocated to any test automation tenants.

At step/operation 502, the web server computing entity 104 determines a throttled agent subset of the plurality of test automation tenants. The throttled agent subset may describe a subset of test automation tenants associated with a test automation platform, where allocated agent subset for a test automaton tenant in the throttled tenant subset fails to satisfy a minimum agent allocation requirement for the test automaton tenant. For example, if no test automation execution agents are allocated to a test automation tenant whose minimum agent allocation requirement describes that at least one automated testing execution agent should optimally be allocated to the particular test automation tenant if the per-agent execution run queue for the particular test automation tenant describes at least one outstanding automated execution run data entity, then the test automation tenant may be in the throttled tenant subset. As another example, if less than n test automation execution agents are allocated to a test automation tenant whose minimum agent allocation requirement describes that at least n automated testing execution agents should optimally be allocated to the particular test automation tenant if the per-agent execution run queue for the particular test automation tenant describes at least one outstanding automated execution run data entity, then the test automation tenant may be in the throttled tenant subset. In some embodiments, multi-tenant execution of a group of automated execution run data entities may require that, given two or more test automation tenants associated with the group of automated execution run data entities, that the automated testing execution agents be allocated to the test automation tenants in a manner that is configured to minimize a count of test automation tenants in the throttled tenant subset. In some embodiments, the web server computing entity 104 ensures that each test automation tenant has at least an absolute minimum number of (e.g., one) automated testing execution agents allocated to it at each time, even if the test automation tenant is in the throttled tenant subset, by ensuring that if needed no automated testing execution agents are available to meet absolute number requirements for all test automation tenants, new automated testing execution agents are spawned as needed.

In some embodiments, the minimum agent allocation requirement describes a minimum count of automated testing execution agents that should optimally be allocated to a particular test automation tenant if the per-agent execution run queue for the particular test automation tenant describes at least one outstanding automated execution run data entity. For example, the minimum agent allocation requirement for a particular test automation tenant may describe how at least one automated testing execution agent should optimally be allocated to the particular test automation tenant if the per-agent execution run queue for the particular test automation tenant describes at least one outstanding automated execution run data entity. As another example, the minimum agent allocation requirement for a particular test automation tenant may describe how at least n automated testing execution agents should optimally be allocated to the particular test automation tenant if the per-agent execution run queue for the particular test automation tenant describes at least one outstanding automated execution run data entity. As another example, the minimum agent allocation requirement for a particular test automation tenant may describe that, given m outstanding automated execution run data entities in the per-agent execution run queue for the particular test automation tenant, at least [m/d] automated testing execution agents that should optimally be allocated to the particular test automation tenant, where d may be a tunable delay parameter for the particular test automation tenant. As yet another example, the minimum agent allocation requirement for a particular test automation tenant may describe that, given m outstanding automated execution run data entities in the per-agent execution run queue for the particular test automation tenant, at least [m/d] automated testing execution agents that should optimally be allocated to the particular test automation tenant, where d may be a tunable delay parameter for the particular test automation tenant. In some embodiments, the minimum agent allocation requirement may be shared across all test automation tenants associated with a test automation platform or across a subset “tier” of test automation tenants associated with a test automation platform. In some embodiments, tunable delay parameters (as described above) may be shared across all test automation tenants associated with a test automation platform or across a subset “tier” of test automation tenants associated with a test automation platform.

At step/operation 503, the web server computing entity 104 generates an agent-tenant allocation recommendation for each automated testing execution agent in the available agent subset that associates the automated testing execution agent to a test automation tenant in the throttled agent subset. As described above, in some embodiments, determining the available agent allocation scheme comprises generating one or more agent-tenant allocation recommendations in a manner that is configured to minimize a count of test automation tenants in the throttled tenant subset, while in other embodiments, determining an available agent allocation scheme comprises generation one or more agent-tenant allocation recommendations in a manner that is configured to minimize a count of test automation tenants whose allocated agent subset is an empty set.

Returning to FIG. 4, at step/operation 405, the web server computing entity 104 executes one or more agent allocation operations based at least in part on the available agent allocation scheme. In some embodiments, executing the agent allocation operations comprises: (i) for internally-executed automated execution run data entities, causing automated testing execution agents associated with the test automation tenants for the noted internally-executed automated execution run data entities to perform operations associated with the noted; and (ii) for each externally-executed automated execution run data entity, identifying an external automated testing execution agent for the test automation tenant that is associated with the automated execution run data entity, receiving an external testing validation key for the external automated testing execution agent, determining an external execution key validation determination for the external automated testing execution agent based at least in part on the external testing validation key, and in response to determining that the external execution key validation determination describes an affirmative external execution key validation determination, providing the automated execution run data entity to the external automated testing execution agent. In some embodiments, executing the agent allocation operations comprises: (i) for internally-executed automated execution run data entities, causing automated testing execution agents associated with the test automation tenants for the noted internally-executed automated execution run data entities to perform operations associated with the noted; and (ii) for each externally-executed automated execution run data entity, identifying an external automated testing execution agent for the test automation tenant that is associated with the automated execution run data entity, providing the automated execution run data entity to the external automated testing execution agent, and receiving execution result data associated with the automated execution run data entity from the external automated testing execution agent. In some embodiments, externally-executed automated testing execution agents are allocated to test automation tenants and/or to externally-executed automated execution run data entities based on minimum agent count requirements for test automation tenants and/or based on maximum agent count requirements for test automation tenants.

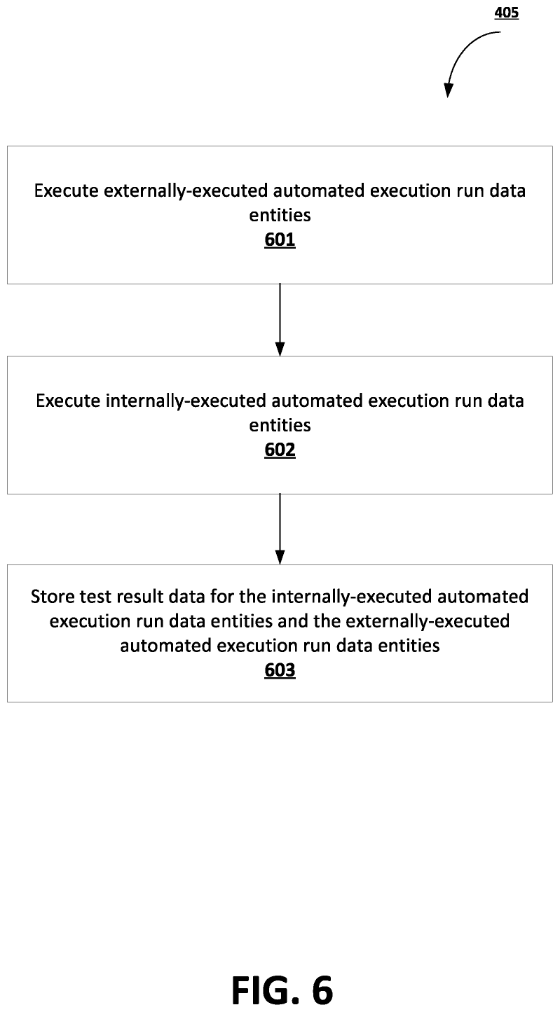

In some embodiments, step/operation 405 may be performed in accordance with the process that is depicted in FIG. 6. The process that is depicted in FIG. 6 begins at step/operation 601 when the web server computing entity 104 executes test automation operations associated with each internally-executed execution run data entity. In some embodiments, an agent management routine is configured to periodically query the group of per-tenant agent run queues to identify an internally-executed subset of the group of automated execution run data entities and generate the group of automated testing execution agents based at least in part on the internally-executed subset.

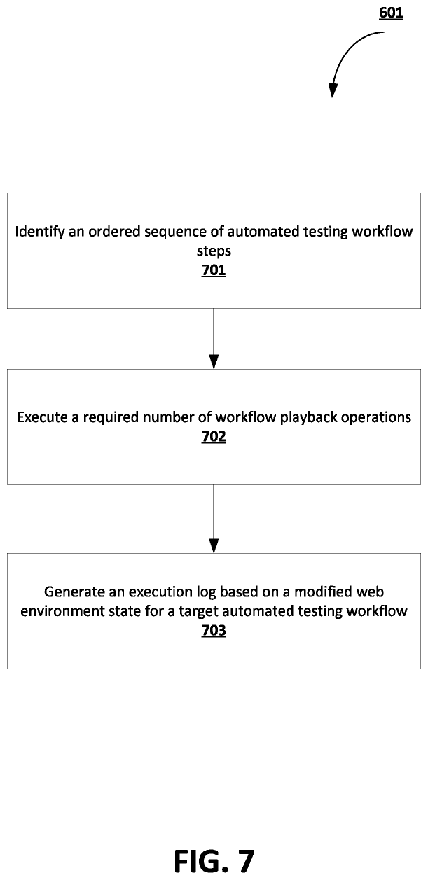

In some embodiments, step/operation 601 may be performed in accordance with the process that is depicted in FIG. 7. The process that is depicted in FIG. 7 begins at step/operation 701 when the web server computing entity 104 identifies an ordered sequence of automated testing workflow steps for an automated testing workflow data entity that corresponds to the internally-executed automated execution run data entity. In some embodiments, the ordered sequence of automated testing workflow steps for the automated testing workflow data entity include all of the automated testing workflow steps of the automated testing workflow data entity as ordered based both on the ordering of automated testing workflow steps within captured page images and ordering of webpages associated with captured page images.

As described above, an automated testing workflow data entity may describe a sequence of web-based actions that may be executed to generate an automated testing operation associated with a software test that is configured to be executed to achieve a particular software testing objective, such as to exercise a particular program path or to verify compliance with a specific operational requirement. For example, the automated testing workflow data entity may describe a sequence of webpages associated with a software testing operation, where each webpage may in turn be associated with a set of automated testing workflow steps. The sequence of webpages and their associated automated testing workflow steps may then be used to generate automation scripts for the software testing operation, where the automation script may be executed by an execution agent in order to execute the software testing operation and generate a software testing output based at least in part on a result of the execution of the automation script. In some embodiments, an automated testing workflow data entity is determined based at least in part on a test case data entity for the corresponding software testing operation, where the test case data entity may describe data associated with a test case, where the test case may in turn describe a specification of the inputs, execution conditions, testing procedure, and expected results that define a test that is configured to be executed to achieve a particular software testing objective, such as to exercise a particular program path or to verify compliance with a specific operational requirement.

In some embodiments, the automated testing workflow data entity may define, for each captured page image associated with an automated testing workflow data entity, a set of automated testing workflow steps. An automated testing workflow step may describe a user action required by a software testing operation associated with a corresponding automated testing workflow data entity, where the user action may be executed with respect to an interactive page element of a webpage associated with a captured page image of the corresponding automated testing workflow data entity. In some embodiments, an automated testing workflow step may be associated with: (i) an image region of the corresponding captured page image that corresponds to the interactive page element for the automated testing workflow step; and (ii) a workflow step action feature element that comprises one or more action features of the user action associated with the automated testing workflow step. For example, if an automated testing workflow step corresponds to the user action of selecting a particular button on a particular webpage, the automated testing workflow step may describe data corresponding to an image region of a captured image for the particular webpage that corresponds to (e.g., is defined in relation to) a location of the particular button on the particular webpage. In the noted example, the automated testing workflow step may describe data associated with action features of a user action that may be used to generate a workflow step action feature element for the automated testing workflow step. An action feature of a user action may describe any property of a user action that is configured to change a state and/or a value of an interactive page element within a webpage. Examples of action features for a user action include: (i) a user action type of the user action that may describe a general input mode of user interaction with the interactive page element associated with the user action; (ii) a user input value of the user action that may describe a value provided by the user to an interactive page element; (iii) a user action sequence identifier of the user action that may describe a temporal order of the user action within a set of sequential user actions executed with respect to interactive page elements of a webpage associated with the user action; and (iv) a user action time of the user action that may describe a captured time of the corresponding user action, and/or the like.

At step/operation 702, the web server computing entity 104 executes a required number of workflow playback operations based at least in part on the ordered sequence until a terminal workflow playback operation that is associated with a target automated testing workflow step that is a first automated testing workflow step with a negative success indicator. In some embodiments, the web server computing entity 104 performs a workflow playback operation for each automated testing workflow step until a first automated testing workflow step that is associated with an interactive page element that cannot be located within a corresponding webpage and/or with respect to which a captured user interaction associated with the automated testing workflow step cannot successfully be performed.

In general, a workflow playback operation may describe an operation that is configured to perform a captured user action associated with a corresponding automated testing workflow step within a web environment of the automated testing workflow data entity that comprises the corresponding automated testing workflow step. In some embodiments, executing a workflow playback operation comprises: (i) identifying a workflow simulation web environment for a webpage associated with the automated testing workflow step for the workflow playback operation; (ii) generating a modified web environment state for the automated testing workflow step by modifying a web environment state of the workflow simulation web environment based at least in part on a captured user interaction for the automated testing workflow step; and (iii) generating the success indicator for the workflow playback operation based at least in part on the modified web environment state for the automated testing workflow step.

As used herein in relation to workflow playback operations, the success indicator may be a value that is configured to describe whether a corresponding workflow playback operation associated with a corresponding automated testing workflow step has successfully executed a captured user interaction associated with the corresponding automated testing workflow step with respect to a web environment defined by a corresponding automated testing workflow data entity that comprises the corresponding automated testing workflow step. In some embodiments, if a corresponding workflow playback operation associated with a corresponding automated testing workflow step has successfully executed a captured user interaction associated with the corresponding automated testing workflow step with respect to a web environment defined by a corresponding automated testing workflow data entity that comprises the corresponding automated testing workflow step, then the success indicator for the corresponding workflow playback operation may be a positive value. In some embodiments, if a corresponding workflow playback operation associated with a corresponding automated testing workflow step has not successfully executed a captured user interaction associated with the corresponding automated testing workflow step with respect to a web environment defined by a corresponding automated testing workflow data entity that comprises the corresponding automated testing workflow step, then the success indicator for the corresponding workflow playback operation may be a negative value. In some embodiments, the success indicator for a workflow playback operation that is associated with an automated testing workflow step may be negative if one of the following conditions is satisfied: (i) no interactive page element is detected at a page region of a corresponding webpage that is determined in accordance with the element location data for the automated testing workflow step; or (ii) an interactive page element is detected at a page region of a corresponding webpage that is determined in accordance with the element location data for the automated testing workflow step, but the detected interactive page element has an element type that is inconsistent with an element type of an interactive page element for the corresponding automated testing workflow step as determined in accordance with the element type data for the automated testing workflows step.

At step/operation 703, the web server computing entity 104 generates the execution log based at least in part on the modified web environment state for the target automated testing workflow step that is associated with the terminal workflow playback operation. The execution log may describe at least one success indicator associated with a workflow playback operation of the required number of workflow playback operations. In some embodiments, the execution log describes an affirmative execution log field for each automated testing workflow step that is associated with the required number of workflow playback operations other than the terminal workflow playback operation. In some embodiments, the execution log describes a negative execution log field for the target automated testing workflow step that is associated with terminal workflow playback operation. In some embodiments, user selection of the negative execution log causes generating user interface data for a workflow step action feature element that is associated with the target automated testing workflow step. In some embodiments, modifying the target automated testing workflow step can be performed via user interaction with the workflow step action feature element.

Returning to FIG. 6, at step/operation 602, the web server computing entity 104 the web server computing entity 104 executes internally-executed automated execution run data entities. In some embodiments, executing the internally-executed automated execution run data entities, for each externally-executed automated execution run data entity, identifying an external automated testing execution agent for the test automation tenant that is associated with the automated execution run data entity, receiving an external testing validation key for the external automated testing execution agent, determining an external execution key validation determination for the external automated testing execution agent based at least in part on the external testing validation key, and in response to determining that the external execution key validation determination describes an affirmative external execution key validation determination, providing the automated execution run data entity to the external automated testing execution agent. In some embodiments, executing the internally-executed automated execution run data entities comprises, for each externally-executed automated execution run data entity, identifying an external automated testing execution agent for the test automation tenant that is associated with the automated execution run data entity, providing the automated execution run data entity to the external automated testing execution agent, and receiving execution result data associated with the automated execution run data entity from the external automated testing execution agent.

At step/operation 603, the web server computing entity 104 stores results data associated with execution of both the externally-executed automated execution run data entities and the internally-executed automated execution run data entities. In some embodiments, the results data for an automated execution run data entity comprise at least one of test outcome data describing which testing operations have succeeded and which have failed. In some embodiments, the results data for an automated execution run data entity comprise one or more captured page images that are generated during the testing of a software application in accordance with the automated execution run data entity.

Thus, as described herein, various embodiments of the present invention provide techniques for allocating test execution resources in an optimized manner among two or more test automation tenants of a test automation platform. For example, various embodiments of the present invention enable generating an available agent allocation scheme that comprises one or more agent-tenant allocation recommendations, wherein each agent-tenant allocation recommendation associates an automated testing execution agent in the available agent subset with a test automation tenant in the throttled tenant subset, and executing one or more agent allocation operations based at least in part on the available agent allocation scheme. The disclosed techniques decrease average user wait-time that may come about as a result of nonoptimal testing resource allocation, thus reducing the computational load on test automation platforms. In this way, various embodiments of the present invention improve the computational efficiency and operational reliability of test automation platforms. For example, consider a scenario in which a user U1 associated with a test automation tenant T1 and a user U2 associated with a test automation tenant T2. In the absence of optimal testing resource allocation, one of U1 and U2 may have to wait while interacting with the test automation platform, which incurs unnecessary computational/operational costs on the noted test automation platform. By reducing this wait time, various embodiments of the present invention improve the computational efficiency and operational reliability of test automation platforms.

### CONCLUSION

Many modifications and other embodiments will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

1. A computer-implemented method for managing multi-tenant execution of a group of automated execution run data entities associated with a plurality of test automation tenants, the computer-implemented method comprising:
identifying, using one or more processors, a total agent pool comprising a group of automated testing execution agents, wherein the total agent pool comprises: (i) for each test automation tenant, an allocated agent subset, and (ii) an available agent subset comprising each automated testing execution agent that is not allocated to the plurality of test automation tenants;
determining, using the one or more processors, a throttled tenant subset of the plurality of test automation tenants, wherein each allocated agent subset for a test automaton tenant in the throttled tenant subset fails to satisfy a minimum agent allocation requirement for the test automaton tenant;
determining, using the one or more processors, an available agent allocation scheme that comprises one or more agent-tenant allocation recommendations, wherein each agent-tenant allocation recommendation associates an automated testing execution agent in the available agent subset with a test automation tenant in the throttled tenant subset; and
executing, using the one or more processors, one or more agent allocation operations based at least in part on the available agent allocation scheme.

2. The computer-implemented method of claim 1, wherein determining the available agent allocation scheme comprises:
generating one or more agent-tenant allocation recommendations in a manner that is configured to minimize a count of test automation tenants in the throttled tenant subset.

3. The computer-implemented method of claim 1, wherein:
the group of automated execution run data entities are determined based at least in part on a group of per-tenant execution run queues; and
each per-tenant execution run queue is associated with a test automation tenant of the plurality of test automation tenants.

4. The computer-implemented method of claim 3, wherein:
the total agent pool is generated by an agent management routine; and
the agent management routine is configured to periodically query the group of per-tenant agent run queues to identify an internally-executed subset of the group of automated execution run data entities and generate the group of automated testing execution agents based at least in part on the internally-executed subset.

5. The computer-implemented method of claim 1, further comprising:
identifying, using the one or more processors, an externally-executed subset of the group of automated execution run data entities; and
for each automated execution run data entity in the externally-executed subset:
identifying, using the one or more processors, an external automated testing execution agent for the test automation tenant that is associated with the automated execution run data entity;
receiving, using the one or more processors, an external testing validation key for the external automated testing execution agent;
determining, using the one or more processors, an external execution key validation determination for the external automated testing execution agent based at least in part on the external testing validation key; and
in response to determining that the external execution key validation determination describes an affirmative external execution key validation determination, providing, using the one or more processors, the automated execution run data entity to the external automated testing execution agent.

6. The computer-implemented method of claim 1, further comprising:
identifying, using the one or more processors, an externally-executed subset of the group of automated execution run data entities;
for each automated execution run data entity in the externally-executed subset:
identifying, using the one or more processors, an external automated testing execution agent for the test automation tenant that is associated with the automated execution run data entity;
providing, using the one or more processors, the automated execution run data entity to the external automated testing execution agent; and
receiving, using the one or more processors, execution result data associated with the automated execution run data entity from the external automated testing execution agent.

7. The computer-implemented method of claim 1, wherein each automated testing execution agent is a standalone execution package.

8. An apparatus for managing multi-tenant execution of a group of automated execution run data entities associated with a plurality of test automation tenants, the apparatus comprising at least one processor and at least one memory including program code, the at least one memory and the program code configured to, with the processor, cause the apparatus to at least:
identify a total agent pool comprising a group of automated testing execution agents, wherein the total agent pool comprises: (i) for each test automation tenant, an allocated agent subset, and (ii) an available agent subset comprising each automated testing execution agent that is not allocated to the plurality of test automation tenants;
determine a throttled tenant subset of the plurality of test automation tenants, wherein each allocated agent subset for a test automaton tenant in the throttled tenant subset fails to satisfy a minimum agent allocation requirement for the test automaton tenant;
determine an available agent allocation scheme that comprises one or more agent-tenant allocation recommendations, wherein each agent-tenant allocation recommendation associates an automated testing execution agent in the available agent subset with a test automation tenant in the throttled tenant subset; and
execute one or more agent allocation operations based at least in part on the available agent allocation scheme.

9. The apparatus of claim 8, wherein determining the available agent allocation scheme comprises:
generating one or more agent-tenant allocation recommendations in a manner that is configured to minimize a count of test automation tenants in the throttled tenant subset.

10. The apparatus of claim 8, wherein:
the group of automated execution run data entities are determined based at least in part on a group of per-tenant execution run queues; and
each per-tenant execution run queue is associated with a test automation tenant of the plurality of test automation tenants.

11. The apparatus of claim 10, wherein:
the total agent pool is generated by an agent management routine; and
the agent management routine is configured to periodically query the group of per-tenant agent run queues to identify an internally-executed subset of the group of automated execution run data entities and generate the group of automated testing execution agents based at least in part on the internally-executed subset.

12. The apparatus of claim 8, wherein the at least one memory and the program code are configured to, with the processor, cause the apparatus to at least:
identify an externally-executed subset of the group of automated execution run data entities;
for each automated execution run data entity in the externally-executed subset:
identify an external automated testing execution agent for the test automation tenant that is associated with the automated execution run data entity;
receive an external testing validation key for the external automated testing execution agent;
determine an external execution key validation determination for the external automated testing execution agent based at least in part on the external testing validation key; and
in response to determining that the external execution key validation determination describes an affirmative external execution key validation determination, provide the automated execution run data entity to the external automated testing execution agent.

13. The apparatus of claim 8, wherein the at least one memory and the program code are configured to, with the processor, cause the apparatus to at least:
identify an externally-executed subset of the group of automated execution run data entities;
for each automated execution run data entity in the externally-executed subset:
identify an external automated testing execution agent for the test automation tenant that is associated with the automated execution run data entity;
provide the automated execution run data entity to the external automated testing execution agent; and
receive execution result data associated with the automated execution run data entity from the external automated testing execution agent.

14. The apparatus of claim 8, wherein each automated testing execution agent is a standalone execution package.

15. A computer program product for managing multi-tenant execution of a group of automated execution run data entities associated with a plurality of test automation tenants, the computer program product comprising at least one non-transitory computer-readable storage medium having computer-readable program code portions stored therein, the computer-readable program code portions configured to:
identify a total agent pool comprising a group of automated testing execution agents, wherein the total agent pool comprises: (i) for each test automation tenant, an allocated agent subset, and (ii) an available agent subset comprising each automated testing execution agent that is not allocated to the plurality of test automation tenants;
determine a throttled tenant subset of the plurality of test automation tenants, wherein each allocated agent subset for a test automaton tenant in the throttled tenant subset fails to satisfy a minimum agent allocation requirement for the test automaton tenant;
determine an available agent allocation scheme that comprises one or more agent-tenant allocation recommendations, wherein each agent-tenant allocation recommendation associates an automated testing execution agent in the available agent subset with a test automation tenant in the throttled tenant subset; and
execute one or more agent allocation operations based at least in part on the available agent allocation scheme.

16. The computer program product of claim 15, wherein determining the available agent allocation scheme comprises:
generating one or more agent-tenant allocation recommendations in a manner that is configured to minimize a count of test automation tenants in the throttled tenant subset.

17. The computer program product of claim 15, wherein:
the group of automated execution run data entities are determined based at least in part on a group of per-tenant execution run queues; and
each per-tenant execution run queue is associated with a test automation tenant of the plurality of test automation tenants.

18. The computer program product of claim 17, wherein:
the total agent pool is generated by an agent management routine; and
the agent management routine is configured to periodically query the group of per-tenant agent run queues to identify an internally-executed subset of the group of automated execution run data entities and generate the group of automated testing execution agents based at least in part on the internally-executed subset.

19. The computer program product of claim 15, wherein the computer-readable program code portions are configured to:
identify an externally-executed subset of the group of automated execution run data entities;
for each automated execution run data entity in the externally-executed subset:
identify an external automated testing execution agent for the test automation tenant that is associated with the automated execution run data entity;
receive an external testing validation key for the external automated testing execution agent;
determine an external execution key validation determination for the external automated testing execution agent based at least in part on the external testing validation key; and
in response to determining that the external execution key validation determination describes an affirmative external execution key validation determination, provide the automated execution run data entity to the external automated testing execution agent.

20. The computer program product of claim 15, wherein the computer-readable program code portions are configured to:
identify an externally-executed subset of the group of automated execution run data entities;
for each automated execution run data entity in the externally-executed subset:
identify an external automated testing execution agent for the test automation tenant that is associated with the automated execution run data entity;
provide the automated execution run data entity to the external automated testing execution agent; and
receive execution result data associated with the automated execution run data entity from the external automated testing execution agent.
